(19) United States
(12) Patent Application Publication
(10) Pub. No.: US 2014/0166519 A1
(43) Pub. Date: Jun. 19, 2014

(54) Carrier For Containers

(71) Applicant: Graphic Packaging International, Inc., Atlanta, GA (US)

(72) Inventor: O'Neal Alexander, Covington, GA (US)

(73) Assignee: Graphic Packaging International, Inc., Atlanta, GA (US)

(21) Appl. No.: 14/134,041

(22) Filed: Dec. 19, 2013

Related U.S. Application Data
(60) Provisional application No. 61/848,004, filed on Dec. 19, 2012.

(51) Int. Cl. B65D 71/40; B31B 1/26

(52) U.S. Cl. CPC B65D 71/40; B31B 1/26
USPC 206/427; 229/117.14; 493/162

(57) ABSTRACT

A carrier for holding a plurality of containers. The carrier comprises panels that extend at least partially around an interior of the carrier. The panels comprise a front panel, a back panel, a bottom panel, at least one top panel foldably connected to one of the front panel and the back panel, and at least one handle panel foldably connected to the top panel. The at least one handle panel has a handle portion forming a handle of the carrier. The at least one top panel comprises container receiving openings for receiving a respective container of the plurality of containers, each container receiving opening extends across the an entire width of the top panel. At least a portion of the top panel and at least a portion of the handle panel are positioned between adjacent containers in the plurality of containers.

### CROSS-REFERENCE TO RELATED APPLICATION

This application claims the benefit of U.S. Provisional Application No. 61/848,004, filed on Dec. 19, 2012.

### INCORPORATION BY REFERENCE

The disclosure of U.S. Provisional Application No. 61/848,004, filed on Dec. 19, 2012, is hereby incorporated by reference as if presented herein in its entirety.

### BACKGROUND OF THE DISCLOSURE

The present invention generally relates to carriers or cartons for holding and displaying containers. More specifically, the present disclosure relates to basket-style carriers.

### SUMMARY OF THE DISCLOSURE

In general, one aspect of the disclosure is directed to a carrier for holding a plurality of containers. The carrier comprises panels that extend at least partially around an interior of the carrier. The panels comprise a front panel, a back panel, a bottom panel, at least one top panel foldably connected to one of the front panel and the back panel, and at least one handle panel foldably connected to the top panel. The at least one handle panel has a handle portion forming a handle of the carrier. The at least one handle panel is folded relative to the top panel. The at least one top panel comprises container receiving openings for receiving a respective container of the plurality of containers, each container receiving opening extends across the entire width of the top panel. At least a portion of the top panel and at least a portion of the handle panel are positioned between adjacent containers in the plurality of containers.

In another aspect, the disclosure is generally directed to a blank for forming a carrier for holding a plurality of containers. The blank comprises panels that comprise a front panel, a back panel, a bottom panel, at least one top panel foldably connected to one of the front panel and the back panel, and at least one handle panel foldably connected to the top panel. The at least one handle panel has a handle portion forming a handle of the carrier formed from the blank. The at least one handle panel is for being folded relative to the top panel. The at least one top panel comprises container receiving openings for receiving a respective container of the plurality of containers. Each container receiving opening extends across the entire width of the top panel. At least a portion of the top panel and at least a portion of the handle panel are positioned between adjacent containers in the plurality of containers in the carrier formed from the blank

In another aspect, the disclosure is generally directed to a method of forming a carrier for containing a plurality of containers. The method comprises obtaining a blank having panels that comprise a front panel, a back panel, a bottom panel, at least one top panel foldably connected to one of the front panel and the back panel, and at least one handle panel foldably connected to the top panel. The at least one handle panel has a handle portion forming a handle of the carrier. The at least one top panel comprises container receiving openings extending across the entire width of the top panel. The method further comprises folding the at least one handle panel relative to the top panel to form the handle and positioning at least a portion of the top panel and at least a portion of the handle panel between adjacent containers in the plurality of containers.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an exterior surface of a blank used to form a carrier according to one embodiment of the disclosure.

FIG. 2 is a top view of the blank with containers being loaded.

FIG. 3 is a perspective view of the partially assembled and loaded carrier.

FIG. 4 is a side view of the assembled and loaded carrier with the handle portion in the raised position.

FIG. 5 is a perspective view of the assembled and loaded carrier with the retention portion in the intermediate position.

FIG. 6 is a side view of the carrier with the handle portion in the lower position.

FIG. 7 is a top view of the assembled and loaded carrier with the handle portion in the lower position.

FIG. 8 is a perspective view of the assembled and loaded carrier with the handle portion in the lower position.

Corresponding parts are designated by corresponding reference numbers throughout the drawings.

### DETAILED DESCRIPTION OF THE EXEMPLARY EMBODIMENT

The present disclosure generally relates to carriers, packages, constructs, sleeves, cartons, or the like, for holding, carrying, and displaying containers such as jars, bottles, cans, etc. The containers can be used for packaging food and beverage products, for example. The containers can be made from materials suitable in composition for packaging the particular food or beverage item, and the materials include, but are not limited to, plastics such as PET, LDPE, LLDPE, HDPE, PP, PS, PVC, EVOH, and Nylon; and the like; aluminum and/or other metals; glass; or any combination thereof.

Carriers according to the present disclosure can accommodate containers of numerous different shapes. For the purpose of illustration and not for the purpose of limiting the scope of the disclosure, the following detailed description describes beverage containers (e.g., glass or plastic bottles) at least partially disposed within the carrier embodiments. In this specification, the terms “lower,” “bottom,” “upper,” “top,” “front,” and “back” indicate orientations determined in relation to fully erected carriers.

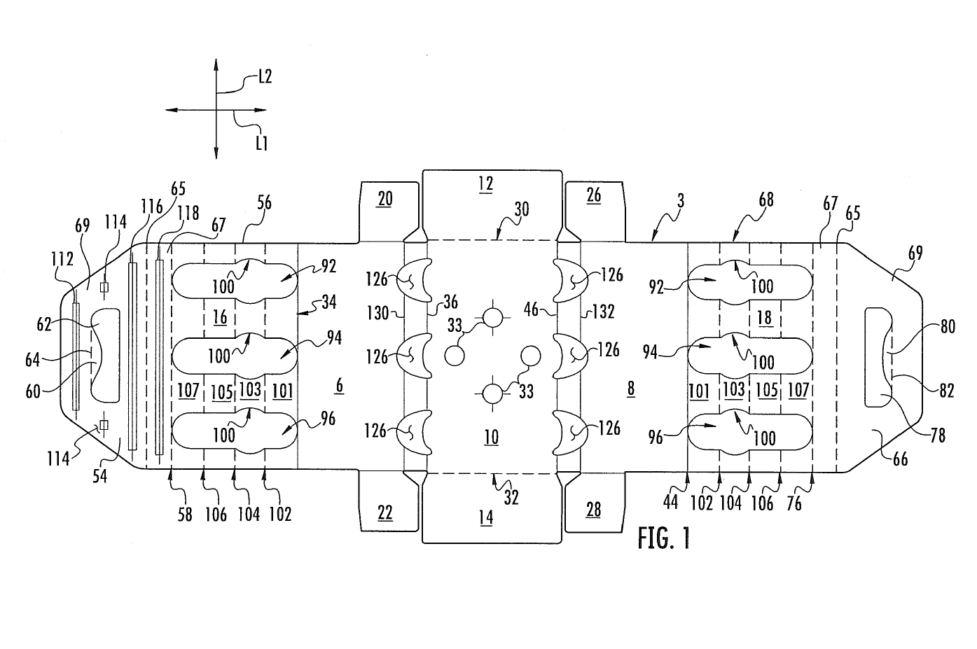

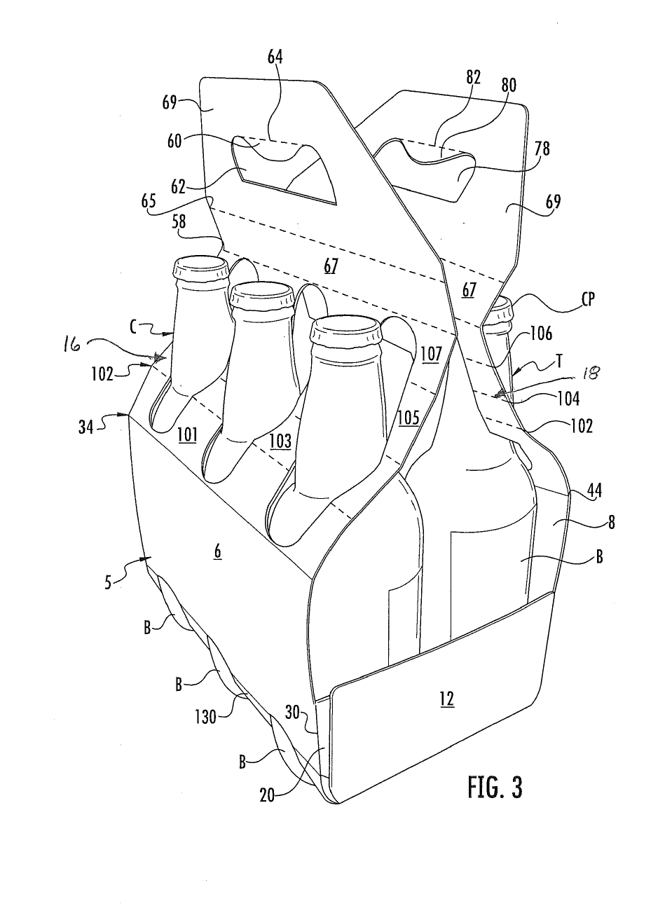

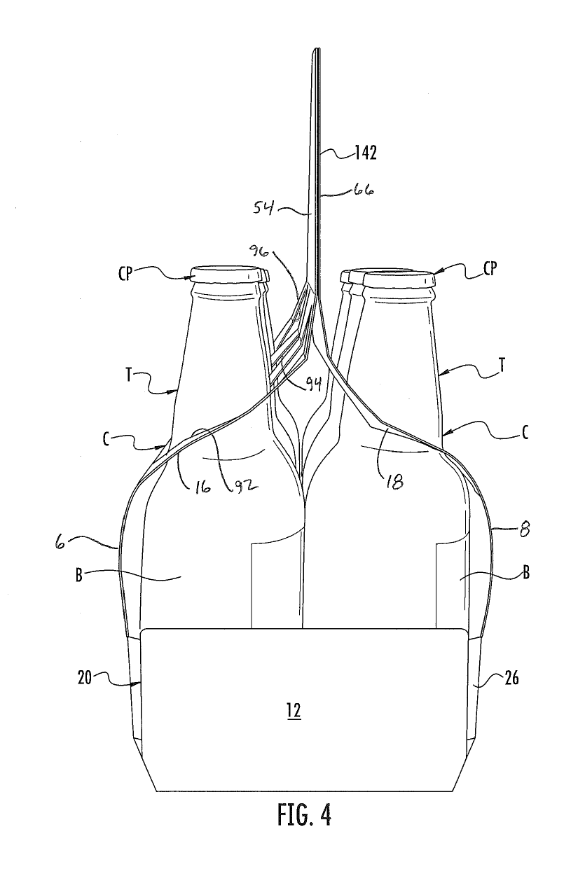

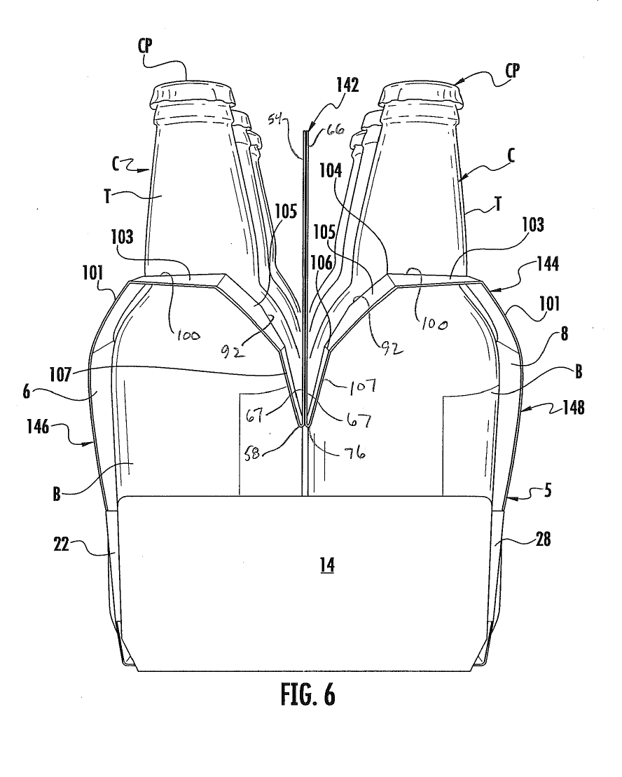

FIG. 1 is a plan view of an exterior side 1 of a blank 3 used to form a carton, package, or carrier 5, in accordance with an exemplary embodiment of the present disclosure. In the illustrated embodiment and as best understood with reference to FIGS. 4 and 6, the containers C are bottles having a wide bottom B and a narrow top T including a cap CP. As shown in FIG. 3, the carrier 5 is sized to contain six containers C. The carrier 5 may be sized and shaped to hold more or less than six containers C. Also, the carrier 5 may hold containers C of other shapes and sizes without departing from the disclosure. The carrier 5 includes a handle 142 that is positionable between a raised position (FIG. 4) and a lowered position (FIG. 6).

The blank 3 has a longitudinal axis L1 and a lateral axis L2. The blank 3 has a front panel 6, a back panel 8, a bottom panel 10, a first side panel 12, and a second side panel 14. The bottom panel 10 is foldably connected to the front panel 6 and to the back panel 8. A first top panel 16 is foldably connected to the front panel 6. A second top panel 18 is foldably connected to the back panel 8.

In one embodiment, the front panel 6 is foldably connected to a first end flap 20 and a second end flap 22. The back panel 8 is foldably connected to a first end flap 26 and a second end flap 28. When the carrier 5 is erected, the end flaps 20, 26 cooperate with the side panel 12 to partially close one end of the carrier and the end flaps 22, 28 cooperate with the side panel 14 to partially close a second end of the carrier. In accordance with alternative embodiments of the disclosure, different flap arrangements can be used for closing the ends of the carrier 5.

The end flaps 20, 26 and side panel 12 may extend along a first marginal area of the blank 3, and may be foldably connected at respective portions of a first longitudinal fold line 30 that extends along at least a portion of the length of the blank 3. The end flaps 22, 28 and side panel 14 may extend along a second marginal area of the blank 3 and may be foldably connected at respective portions of a second longitudinal fold line 32 that also extends along at least a portion of the length of blank 3. The longitudinal fold lines 30, 32 may be, for example, substantially straight, or offset at one or more locations to account for blank thickness or other factors.

In the illustrated embodiment, the front panel 6 is respectively foldably connected to the first top panel 16 at a lateral fold line 34 and is foldably connected to the bottom panel 10 at a lateral fold line 36. The back panel 8 is respectively foldably connected to the second top panel 18 at a lateral fold line 44 and is foldably connected to the bottom panel 10 at a lateral fold line 46. In one embodiment, the bottom panel 10 includes openings 33. The openings 33 can allow for accumulated moisture to drain from carton 5. In accordance with alternative embodiments of the disclosure, the openings 33 can be otherwise shaped, positioned, arranged, and/or omitted without departing from the disclosure.

In one embodiment, the first top panel 16 is foldably connected to a first handle panel 54 at lateral fold line 58. The first handle panel 54 comprises handle features including a respective handle opening 62 and handle flap 60 foldably connected to the first handle panel 54 at respective lateral fold line 64. The second top panel 18 is foldably connected to a second handle panel 66 at lateral fold line 76. The second handle panel 66 comprises handle features including a respective handle opening 78 and handle flap 80 foldably connected to the second handle panel 66 at respective lateral fold line 82. In one embodiment, the first handle panel 54 and second handle panel 66 have lateral fold lines 65 that connect base portions 67 of the handle panels 54, 66 to distal portions 69 of the handle panels.

In one embodiment, the first top panel 16 comprises lateral fold lines 102, 104, 106 for positioning the first top panel 16 relative to the first handle panel 54. As shown in FIG. 1, the top panel 16 includes three openings 92, 94, 96 extending between the fold lines 34, 58 and across fold lines 102, 104, 106. In one embodiment the three openings 92, 94, 96 may be approximately 4.2 inches in length in the longitudinal L1 direction. Each of the three openings 92, 94, 96 are elongate and have an off-center notch 100 being wider than the remaining portion of the openings and suited to contour around the neck T of the container C. In the illustrated embodiment, each of the openings 92, 94, 96 extend across the entire width of the top panel 16 between fold lines 34, 58, however the openings 92, 94, 96 could extend into the first handle panel 54 and/or the front panel 6 without departing from the disclosure. The notch 100 may be curved, square, or have other configurations, and/or be omitted without departing from the disclosure. The first top panel 16 comprises four portions 101, 103, 105, 107 that are independently moveable and positionable by way of the lateral fold lines 102, 104, 106. In one embodiment, the openings 92, 94, 96 each extend across each of the four portions 101, 103, 105, 107 of the top panel 16, but the top panel and/or the openings could be otherwise arranged.

In the illustrated embodiment, the portions 101, 103, 105, 107 and the fold lines 102, 104, 106, allow the first top panel 16 to be shaped and contoured to be other than flat (i.e., such as arch or curve shaped). In one embodiment, the lateral fold lines 102, 104, 106 allow the portions 101, 103, 105, 107 of the first top panel 16 to be positioned as shown in FIG. 6 so that the top panel 16 has a generally arch-shaped profile extending from the front panel 6 to the handle panel 54 when the carrier 5 is assembled. The lateral fold lines 102, 104, 106 and portions 101, 103, 105, 107 could be otherwise shaped, positioned, arranged, and/or omitted without departing from the disclosure.

In the illustrated embodiment, the second top panel 18 is shaped similar to the first top panel 16 and includes identical features that are identified by like reference numbers as the features described above for the first top panel 16. In one embodiment, the first handle panel 54 includes glue lines 112, 114, 116, 118 for adhering the first handle panel 54 to the second handle panel 66. Alternatively, the first handle panel 54 and the second handle panel 66 could be affixed together by other means, such as stapling or a locking arrangement with male and female locking tabs, without departing from the disclosure.

In the illustrated embodiment, the lower portions of each of the front panel 6 and the back panel 8 comprise three generally crescent-shaped apertures 126. In one embodiment, the apertures 126 extend between a respective lateral fold lines 36, 46 adjacent the bottom panel 10 and a respective lateral fold line 130, 132 that extends across a respective front or back panel 6, 8. In one embodiment, the apertures 126 extend into portions of the bottom panel 10. Once the carrier 5 is erected, the apertures 126 secure the base B of container C such that as the bottom edge of a respective container extends outward from an aperture 126 and the aperture limits movement of a respective container. Alternatively, one or more of the apertures 126 could be otherwise shaped, arranged, configured, and/or omitted without departing from the disclosure.

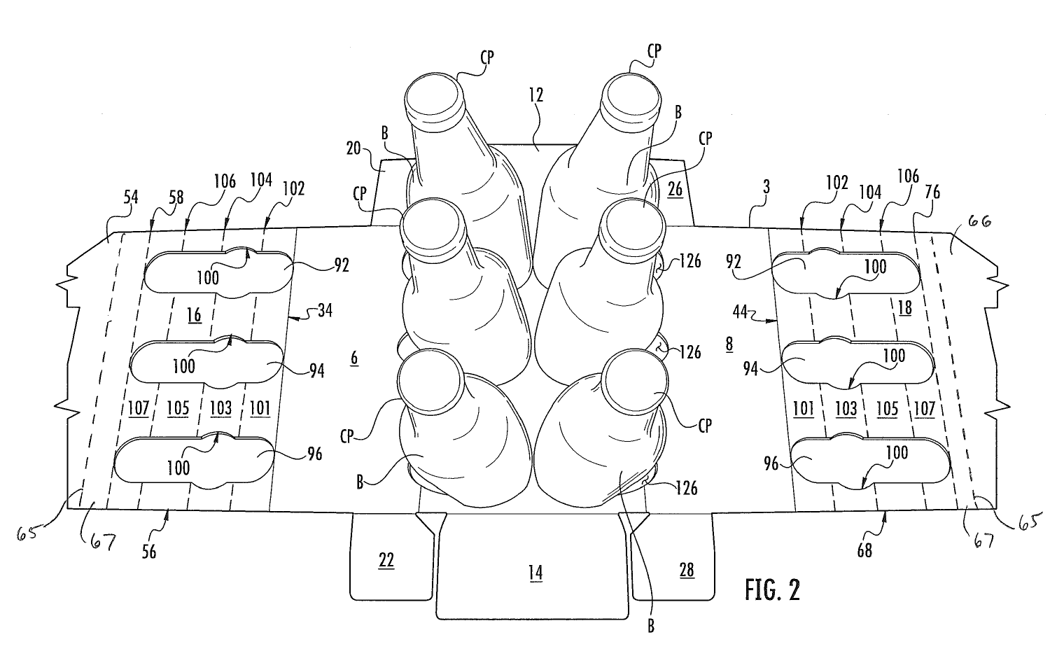

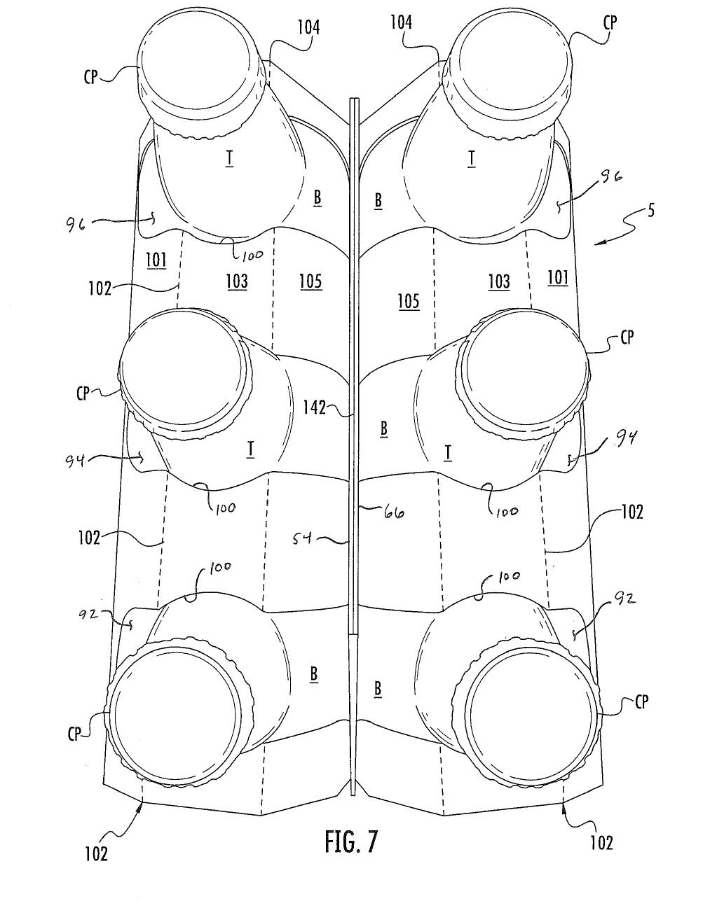

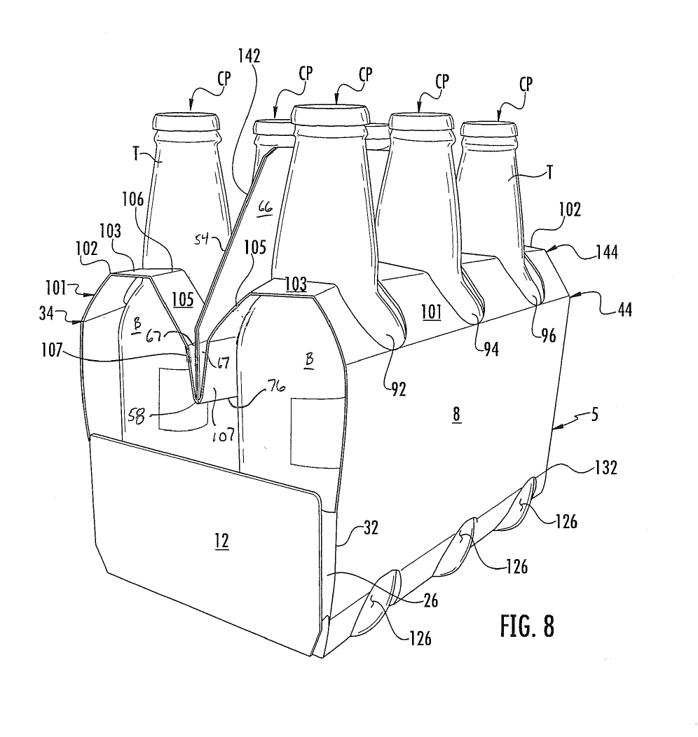

With reference to FIGS. 2-8, in one exemplary method of erection, the carrier 5 may be erected from the blank 3 by first positioning the containers C on the bottom panel 10. The containers C may be aligned with a respective aperture 126 so that a portion of the bottom B of a container C is located above an aperture 126. The first side panel 12 and the second side panel 14 may be folded upward away from the bottom panel 10 along longitudinal fold lines 30, 32. The front panel 6 and the back panel 8 may then be folded along lateral fold lines 36, 46 such that end flaps 20 and 26 are in face to face contact with the first side panel 12 and end flaps 22 and 28 are in face to face contact with the second side panel 14. The exterior surface of the end panels 20, 22, 26, 28 can be secured to the interior surface of the first side panel 12 and the interior surface of the second side panel 14 with adhesive (not shown) placed between the end flaps 20, 22, 26, 28 and the first side panel 12 and second side panel 14 prior to positioning the panels in face-to-face contact as shown in FIG. 3.

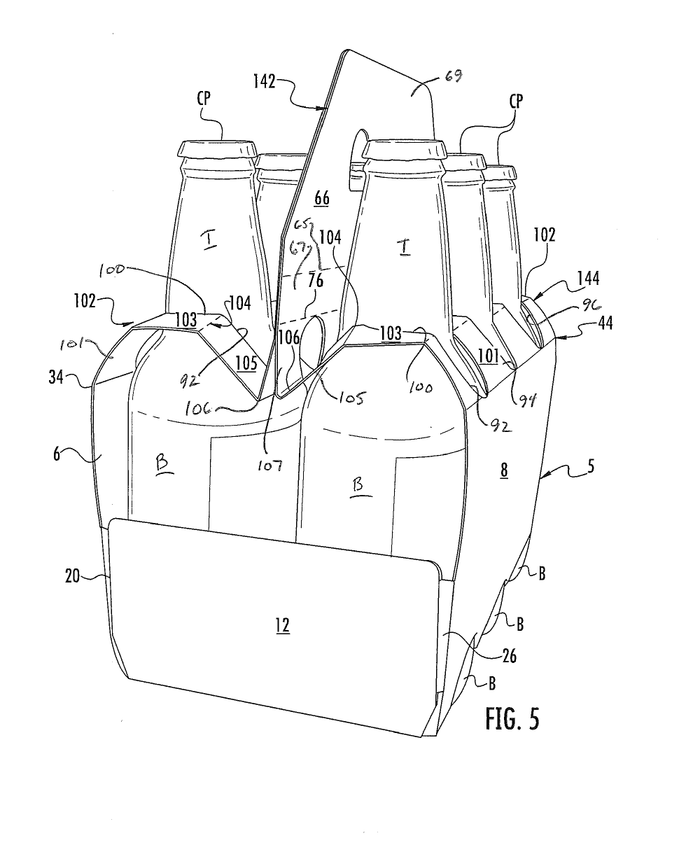

Next, the caps CP of containers C are moved through the openings 92, 94, 96, in the top panels 16, 18, as shown in FIG. 3. The interior face of the first handle panel 54 is positioned to be in face-to-face contact with the interior face of the second handle panel 66. In one embodiment, glue may be positioned on the interior of first handle panel 54, as shown in FIG. 1, prior to the first handle panel 54 and the second handle panel 66 being placed into face-to-face contact. The first and second handle panels 54, 66 may be secured together, such that the handle openings 62, 78 are aligned and in the raised position, as shown in FIG. 4. The secured together first and second handle panels 54, 66 and first and second top panels 16,18 cooperate to form a carrier handle 142 and retention portion 144 of the carrier 5 as shown in FIG. 5.

FIGS. 5-8, show steps to securely retain the bottles for storage and transportation. The first and second top panels 16, 18 are folded upward at fold lines 106 and are positioned to extend between the front and back panels 6, 8 and the first and second handle panels 54, 66. The first and second top panels 16, 18 are secured between the containers C dividing the carrier 5 into two sides 146, 148, as shown in FIG. 6, by pushing the first and second handle panels 54, 66 downward to the lowered position. The containers C apply a contact/compression force to hold portions of the first and second top panels 16, 18 and portions of the handle panels 54, 66 between the containers C in the position shown in FIG. 6. The compression force applied by the containers C keeps the top panels 16, 18 and handle panels 54, 66 in the lowered position with the carrier handle 142 in the lowered position as shown in FIGS. 6-8. If all the containers C on one side of the carrier 5 are removed, the compression force is eliminated and the top panels 16, 18 and handle panels 54, 66 are released and are free to raise upward from the lowered or loaded position shown in FIGS. 6-8 to the raised position. The containers C and features (e.g., top panels 16, 18, carrier handle 142, etc.) of the carrier 5 may be otherwise positioned, shaped, and/or arranged without departing from this disclosure.

In one embodiment, the carrier 5 may be carried at the carrier handle 142 by pushing flaps 64, 80 to either side then grasping the handle panels 54, 66. Containers C can be removed from the carrier 5 by pulling the carrier handle 142 upward to the raised position as shown in FIG. 4. Once the carrier handle is in the raised position, the containers C can be removed by pulling containers C through the respective openings 92, 94, 96. As noted above, if the containers C on one side of the carrier 5 are removed, the holding force acting upon the top panels 16, 18 will be eliminated, causing the handle panels 54, 66 to be released and move to the raised position in FIG. 4. The containers C can be removed from the carrier by other tearing or dispensing features without departing from the disclosure.

As shown in FIG. 6, in the lowered or retaining position of the handle 142, at least a portion of each of the top panels 16, 18 and at least a portion of the handle panels 54, 66 is between the bottom portion B of two adjacent containers C in respective rows of containers. In one embodiment, portions 107 of the top panels 16, 18 and the base portions 67 of the handle panels 54, 66 are located between the base portion B of the adjacent containers C of each respective row. In the lowered, retaining position of the handle 142, the handle 142 can be pushed downward so that the base portions 67 of the handle are adjacent and generally parallel to the portions 107 of the top panels 16, 18. Further, the base portions 67 can be arranged to be in face-to-face contact with a respective portion 107 such that the portions 107 can be folded approximately 180 degrees at the fold lines 58, 76. As shown in FIG. 6, a portion of the base portion B of each container C is received in a respective opening 92, 94, 96 in the top panels 16, 18. The handle 142 and top panels 16, 18 of the carrier 5 can be otherwise shaped, arranged, and or configured without departing from the disclosure.

The exemplary carrier embodiment discussed above accommodates six containers C arranged in two rows of three containers, but the present disclosure is not limited to these numbers. As one example, additional containers may be accommodated by increasing the size of the blank 3 (e.g., in the lateral direction L2 in FIG. 1) and forming additional container-receiving spaces therein. Also, the blank 3 could have less than six container-receiving spaces without departing from the disclosure.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding a plurality of containers, the carrier comprising:
panels that extend at least partially around an interior of the carrier, the panels comprise a front panel, a back panel, a bottom panel, at least one top panel foldably connected to one of the front panel and the back panel, and at least one handle panel foldably connected to the top panel,
the at least one handle panel has a handle portion forming a handle of the carrier, the at least one handle panel is folded relative to the top panel,
the at least one top panel comprises container receiving openings for receiving a respective container of the plurality of containers, each container receiving opening extends across the entire width of the top panel, and
at least a portion of the top panel and at least a portion of the handle panel being positioned between adjacent containers in the plurality of containers.

2. The carrier of claim 1 wherein the top panel comprises a first portion foldably connected to one of the front panel and the back panel, a second portion foldably connected to the first portion, a third portion foldably connected to the second portion, and a fourth portion foldably connected to the third portion and the at least one handle panel.

3. The carrier of claim 2 wherein the container receiving openings extend across the first portion, the second portion, the third portion, and the fourth portion.

4. The carrier of claim 2 wherein the top panel comprises a first fold line foldably connecting the first potion and the second portion, a second fold line foldably connecting the second portion and the third portion, and a third fold line foldably connecting the third portion and the fourth portion.

5. The carrier of claim 4 wherein the top panel is foldably connected to the one of the front panel and the back panel at a fourth fold line and the top panel is foldably connected to the at least one handle panel at a fifth fold line, the container receiving openings extending from the fourth fold line to the fifth fold line.

6. The carrier of claim 2 wherein the first portion extends upwardly from the one of the front panel and the back panel, the second portion extends generally parallel to the bottom panel, the third portion extends downwardly from the second portion, and the fourth portion extends downwardly from the third portion.

7. The carrier of claim 6 wherein the top panel has a generally arch-shaped profile from the one of the front panel and the back panel to the at least one handle panel.

8. The carrier of claim 1 wherein the containers comprise bottles that have a upper portion and a bottom portion, the bottom portion being wider than the upper portion, at least a portion of the top panel and at least a portion of the at least one handle panel being between the bottom portion of two adjacent containers.

9. The carrier of claim 8 wherein at least a portion of the bottom portion of one of the two adjacent containers is received in an opening of the container receiving openings.

10. The carrier of claim 8 wherein the at least a portion of the top panel and the at least a portion of the at least one handle panel are adjacent and generally parallel at a location between the bottom portion of the two adjacent containers.

11. The carrier of claim 8 wherein the front panel and the back panel have a respective lower portion that comprises a plurality of apertures for receiving a portion of the bottom portion of the containers.

12. The carrier of claim 11 wherein the plurality of apertures are generally crescent-shaped.

13. The carrier of claim 1 wherein the at least one top panel comprises a first top panel foldably connected to the front panel and a second top panel foldably connected to the back panel, the at least one handle panel comprises a first handle panel foldably connected to the first top panel and a second handle panel foldably connected to the second top panel.

14. The carrier of claim 13 wherein the containers comprise a first row of containers received in the container receiving openings of the first top panel and a second row of containers received in the container receiving openings of the second top panel.

15. The carrier of claim 14 wherein the first handle panel and the second handle panel are in face-to-face contact to form the handle located between the first row of containers and the second row of containers.

16. A blank for forming a carrier for holding a plurality containers, the blank comprising:
panels that comprise a front panel, a back panel, a bottom panel, at least one top panel foldably connected to one of the front panel and the back panel, and at least one handle panel foldably connected to the top panel,
the at least one handle panel has a handle portion forming a handle of the carrier formed from the blank, the at least one handle panel is for being folded relative to the top panel,
the at least one top panel comprises container receiving openings for receiving a respective container of the plurality of containers, each container receiving opening extends across the entire width of the top panel, and
at least a portion of the top panel and at least a portion of the handle panel being positioned between adjacent containers in the plurality of containers in the carrier formed from the blank.

17. The blank of claim 16 wherein the top panel comprises a first portion foldably connected to one of the front panel and the back panel, a second portion foldably connected to the first portion, a third portion foldably connected to the second portion, and a fourth portion foldably connected to the third portion and the at least one handle panel.

18. The blank of claim 17 wherein the container receiving openings extend across the first portion, the second portion, the third portion, and the fourth portion.

19. The blank of claim 17 wherein the top panel comprises a first fold line foldably connecting the first potion and the second portion, a second fold line foldably connecting the second portion and the third portion, and a third fold line foldably connecting the third portion and the fourth portion.

20. The blank of claim 19 wherein the top panel is foldably connected to the one of the front panel and the back panel at a fourth fold line and the top panel is foldably connected to the at least one handle panel at a fifth fold line, the container receiving openings extending from the fourth fold line to the fifth fold line.

21. The blank of claim 16 wherein the containers comprise bottles that have a upper portion and a bottom portion, the bottom portion being wider than the upper portion, at least a portion of the top panel and at least a portion of the at least one handle panel are for being positioned between the bottom portion of two adjacent containers in the carrier formed form the blank.

22. The blank of claim 21 wherein the at least a portion of the top panel and the at least a portion of the at least one handle panel are for being positioned adjacent and generally parallel at a location between the bottom portion of the two adjacent containers in the carrier formed from the blank.

23. The blank of claim 21 wherein the front panel and the back panel have a respective lower portion that comprises a plurality of apertures for receiving a portion of the bottom portion of the containers in the carrier formed from the blank.

24. The blank of claim 23 wherein the plurality of apertures are generally crescent-shaped.

25. The blank of claim 16 wherein the at least one top panel comprises a first top panel foldably connected to the front panel and a second top panel foldably connected to the back panel, the at least one handle panel comprises a first handle panel foldably connected to the first top panel and a second handle panel foldably connected to the second top panel.

26. A method of forming a carrier for containing a plurality of containers, the method comprising:
obtaining a blank having panels that comprise a front panel, a back panel, a bottom panel, at least one top panel foldably connected to one of the front panel and the back panel, and at least one handle panel foldably connected to the top panel, the at least one handle panel has a handle portion forming a handle of the carrier, the at least one top panel comprises container receiving openings extending across the an entire width of the top panel;
folding the at least one handle panel relative to the top panel to form the handle;
positioning at least a portion of the top panel and at least a portion of the handle panel between adjacent containers in the plurality of containers.

27. The method of claim 26 wherein the top panel comprises a first portion foldably connected to one of the front panel and the back panel, a second portion foldably connected to the first portion, a third portion foldably connected to the second portion, and a fourth portion foldably connected to the third portion and the at least one handle panel.

28. The method of claim 27 wherein the container receiving openings extend across the first portion, the second portion, the third portion, and the fourth portion.

29. The method of claim 27 wherein the top panel comprises a first fold line foldably connecting the first portion and the second portion, a second fold line foldably connecting the second portion and the third portion, and a third fold line foldably connecting the third portion and the fourth portion.

30. The method of claim 29 wherein the top panel is foldably connected to the one of the front panel and the back panel at a fourth fold line and the top panel is foldably connected to the at least one handle panel at a fifth fold line, the container receiving openings extending from the fourth fold line to the fifth fold line.

31. The method of claim 27 further comprising positioning the top panel so that the first portion extends upwardly from the one of the front panel and the back panel, the second portion extends generally parallel to the bottom panel, the third portion extends downwardly from the second portion, and the fourth portion extends downwardly from the third portion.

32. The method of claim 31 wherein the top panel has a generally arch-shaped profile from the one of the front panel and the back panel to the at least one handle panel.

33. The method of claim 26 wherein the containers comprise bottles that have a upper portion and a bottom portion, the bottom portion being wider than the upper portion, and at least a portion of the top panel and at least a portion of the at least one handle panel is between the bottom portion of two adjacent containers.

34. The method of claim 33 further comprising positioning at least a portion of the bottom portion of one of the two adjacent containers in an opening of the container receiving openings.

35. The method of claim 33 wherein the at least a portion of the top panel and the at least a portion of the at least one handle panel are adjacent and generally parallel at a location between the bottom portion of the two adjacent containers.

36. The method of claim 33 wherein the front panel and the back panel have a respective lower portion that comprises a plurality of apertures and the method comprises positioning the bottom portion of the containers in a respective aperture of the plurality of apertures.

37. The method of claim 36 wherein the plurality of apertures are generally crescent-shaped.

38. The method of claim 26 wherein the at least one top panel comprises a first top panel foldably connected to the front panel and a second top panel foldably connected to the back panel, the at least one handle panel comprises a first handle panel foldably connected to the first top panel and a second handle panel foldably connected to the second top panel.

39. The method of claim 38 wherein the containers comprise a first row of containers received in the container receiving openings of the first top panel and a second row of containers received in the container receiving openings of the second top panel.

40. The method of claim 39 further comprising positioning the first handle panel and the second handle panel in face-to-face contact to form the handle and pushing the handle down so that at least a portion of the first handle panel and at least a portion of the second handle panel are between the first row of containers and the second row of containers.

41. The method of claim 40 wherein at least a portion of the first top panel and at least a portion of the second top panel are between the first row of containers and the second row of containers.
